(19) United States
(12) Patent Application Publication
(10) Pub. No.: US 2009/0323350 A1
(43) Pub. Date: Dec. 31, 2009

(54) HIGH-INTENSITY DISCHARGE LAMP FOR SPOT LIGHTING

(75) Inventors: Lei Deng, Richmond Heights, OH (US); Matthew Bugenske, Cleveland Heights, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/555,567

(22) Filed: Sep. 8, 2009

Related U.S. Application Data
(63) Continuation of application No. 11/339,104, filed on Jan. 25, 2006.

(51) Int. Cl. F21V 7/00

(52) U.S. Cl. 362/296.01

(57) ABSTRACT

The present invention relates to a bi-curved lamp. The lamp includes a high-intensity discharge light source and a reflector. The reflector is disposed to receive light from the high-intensity light source and direct the light in a desired manner. The reflector includes a first light reflecting conformation for forming a substantially uniform spot beam angle and a second light reflecting conformation different than the first conformation.

### BACKGROUND OF THE INVENTION

The present disclosure relates to a high-intensity discharge lamp. It finds particular application in conjunction with MR spot lamps, and will be described with particular reference thereto. However, it is to be appreciated that the present disclosure is also amenable to other like applications.

“MR” stands for multifaceted reflector, a pressed glass reflector with an inside (reflecting side) surface composed of facets and covered by a reflective coating. These facets provide optical control by gathering light from a light source to create a concentrated beam of light. The reflectors of some MR lamps have a smooth inside surface instead of facets, but they are still called MR lamps by convention.

A reflective coating of MR lamps can be either dichroic or aluminum. A dichroic coating is typically a thin, multi-layer dielectric (non-metallic film) that allows infrared radiation heat) from the light source to pass through the reflector while it reflects visible radiation (light) forward. The aluminum coating is usually a thin film of aluminum that, unlike the dichroic coating, reflects both infrared and visible radiation. Some MR lamps have a cover glass on a front end of the reflector.

MR lamps are available in different sizes. The size is generally determined by the maximum diameter of the lamp in eighth-of-an-inch increments (1 inch equals 2.5 centimeters). The most common MR lamp, the MR16, is 16 eighths of an inch or 2 inches (approximately 5 centimeters) in diameter at its largest circumference, hence the name “MR16.” Other sizes include MR8 (1 inch, or 2.5 centimeters, diameter) and MR11 (1⅜ inches, or 3.5 centimeters, diameter).

The light source of MR lamps is conventionally a single-ended quartz halogen filament capsule. One commercially available example of such a MR16 spot lamp is the GE Lighting Precise MR16 Halogen lamp. This display lamp includes a bi-curved reflector which provides a light spot having less than a 15° spot beam angle. The prior art is not an HID MR16 lamp, the rim to focal point length is shorter (for example, <18 mm), and the distance from focal point to the bottom base end is also much shorter (for example, <18 mm). Further this structure has a bright ring at a wide angle, approximately 67.5 degrees. Because the prior art lamp produces a bright surrounding ring at a wide angle, color and light uniformity is less than desired.

Recent developments have incorporated a high-intensity discharge (HID) light source into MR lamps. High-intensity discharge lamps generally include high-pressure sodium, metal halide (including ceramic metal halide (CMH)), and mercury vapor lamps. Like fluorescent lamps, HID lamps require ballasts to provide the proper starting voltage and to regulate current during operation. HID lamps generally offer higher lamp efficacy and higher light output than incandescent or fluorescent lamps.

HID lamps typically include a sealed arc tube inside a quartz or glass envelope, outer jacket or hermetic capsule. The inner arc tube is filled with elements that emit light when ionized by electric current. An inside surface of the capsule may be coated with a diffusing material or with phosphors that both diffuse the light and improve the color properties of the lamp. A unique characteristic of metal halide lamp arc tubes, especially ceramic metal halide arc tubes, is the use of long legs that extend from each end of the light emitting arc tube body. Because of the need for the capsule to accommodate the arc tube long legs, the ceramic metal halide capsules are typically much longer than halogen capsules.

Consequently, there are generally four constraints in designing HID MR spot lamps. First, the HID MR reflector has to accommodate the extended long legs of the arc tubes. Second, the reflector has to satisfy existing industrial standardized MR lamp outlines. Third, the HID MR spot lamp has to provide a desired beam pattern, for example, a light spot having less than an approximately 15° spot beam angle, good color uniformity, and good light uniformity. Fourth, the HID MR spot lamp has to maximize center beam candela power (CBCP), which is the luminous intensity at the center of a beam, expressed in candelas (cd).

Accordingly, it is desirable to develop a new and improved MR spot lamp that accommodates a HID light source and achieves a less than approximately 15° spot beam angle with good color and light uniformity.

### BRIEF DESCRIPTION OF THE INVENTION

A lamp is provided. The lamp includes a high-intensity discharge light source and a reflector. The reflector is disposed to receive light from the high-intensity light source and direct the light in a desired manner. The reflector includes a first light reflecting conformation for forming a substantially uniform spot beam angle and a second light reflecting conformation different than the first conformation.

A display lamp includes a high-intensity discharge light source and a bi-curved reflector. The reflector is disposed to receive light from the high-intensity light source and direct the light in a desired manner. The reflector has a first reflective section shaped to form a spot beam angle and a second diffused section extending from the first reflective section having a diffused surface for diffusing light around the spot beam angle.

The assembly includes a high-intensity discharge light source and a bi-curved reflector disposed to receive light from the high-intensity light source and direct the light in a desired manner. The reflector has a first reflective section and a second diffused section extending from the first reflective section. The bi-curved reflector shortens an effective distance between a rim located at an open end of the second diffused section and a focal point of the reflector. The first reflective section achieves less than approximately 15° spot beam angle having color uniformity and beam uniformity.

### BRIEF DESCRIPTION OF THE DRAWINGS

FIG. 1 is a schematic cross-sectional view of a prior art low voltage display lamp.

FIG. 2 is a schematic cross-sectional view of a prior art multifaceted display lamp having a high intensity discharge light source.

FIG. 3 is a schematic cross-sectional view of a multifaceted display lamp having a high intensity discharge light source according to the present invention.

FIG. 4 is a schematic cross-sectional view of the lamp of FIG. 3 showing focal length distances.

FIGS. 5 and 6 are candela power distribution comparisons between the lamp of FIG. 3 and prior art lamps.

### DETAILED DESCRIPTION OF THE INVENTION

As used herein, “MR” refers to a multifaceted display lamp as is generally known in the art. MR16 lamps for example are one type of MR lamp having a nominal diameter of two inches, generally having confined beams, and the light intensity drops sharply at the edge of the beam.

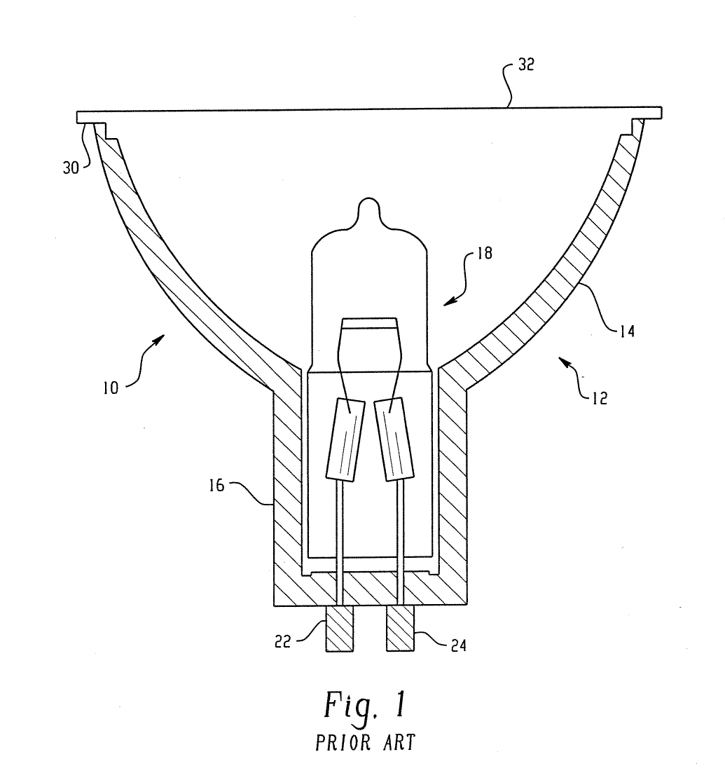

With reference to FIG. 1, illustrated is a conventional low voltage display lamp 10. The lamp generally includes a reflector 12 having a single light reflecting conformation 14 and a base or neck 16 extending from a first end of the light reflecting conformation. The single light reflecting conformation is of a parabolic shape (or elliptical shape) and includes a reflective coating. A conventional halogen light source 18 is disposed within the reflector 12. Terminals 22, 24 are connected to the light source and extend through the base 16 for electrically coupling the base to a lamp socket (not shown). A rim 30 is located at a second or open end of the first light reflecting conformation. The rim defines an opening adapted to receive a lens or light transmissive cover 32. This display lamp 10 generally has a shorter life and is less energy efficient due to the nature of the halogen technology.

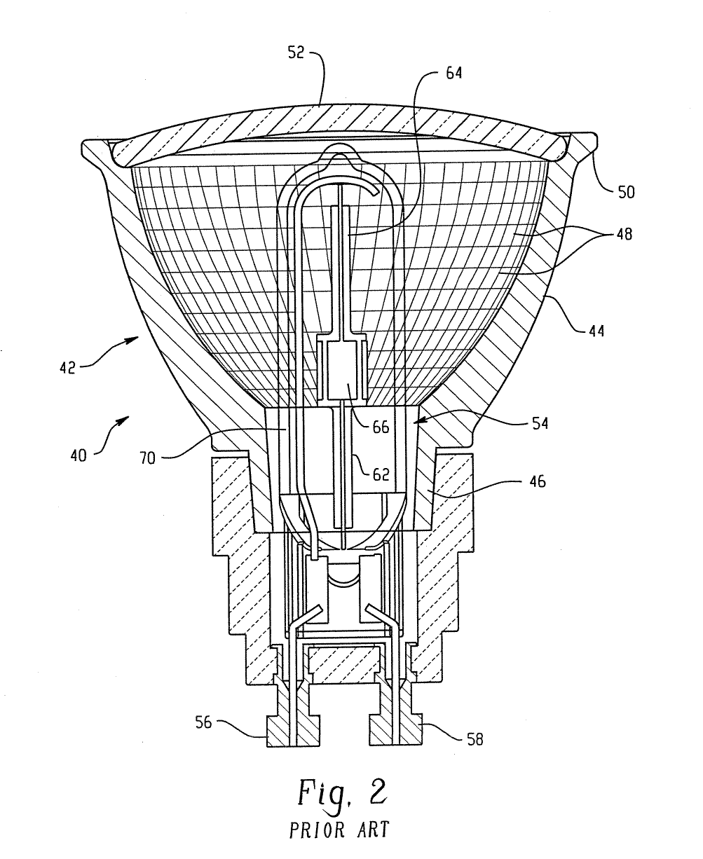

With reference to FIG. 2, illustrated is another example of a conventional multifaceted display lamp 40. The lamp generally includes a reflector 42 having a single light reflecting conformation 44 and a base or neck 46 extending from a first end of the light reflecting conformation. The single light reflecting conformation is of a parabolic shape (or elliptical shape) and includes a plurality of facets 48 and a reflective coating. A rim 50 is located at a second or open end of the first light reflecting conformation. The rim defines an opening adapted to receive a lens or light transmissive cover 52. A high-intensity discharge (HID) light source 54 is disposed within the reflector 42. Terminals 56, 58 electrically connect the HID light source 54 to a lamp socket (not shown).

As indicated in the Background, the HID light source 54, particularly a quartz or ceramic metal halide light source, usually has elongated legs 62, 64 that extend from opposite axial ends of a discharge chamber or light emitting arc tube body 66. An HID capsule 70 encloses the light emitting arc tube body and legs, and results in a light source that is typically much longer than halogen light sources. Thus, the reflector 42 and the base 46 are dimensioned accordingly to accommodate the HID capsule. Conventionally, the reflector 42 is elongated to house a significant portion of the HID light source. However, because this prior art lamp 40 utilizes an elongated reflector 42 having a single parabolic or elliptical light reflecting conformation 44, generally only a flood beam pattern is produced. The display lamp 40 fails to achieve a less than 15° spot beam angle with good color and light uniformity.

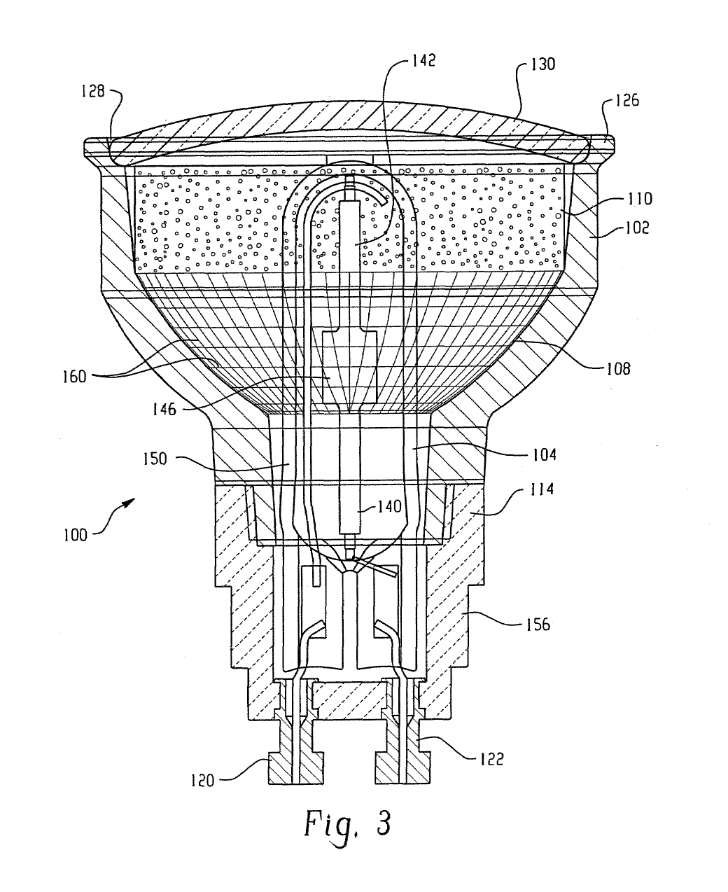

With reference to FIG. 3, a multifaceted display lamp 100 according to the present disclosure is shown. The lamp includes a bi-curved reflector 102 disposed to receive light from a high-intensity discharge (HID) light source 104 and direct the light from the HID light source in a desired manner. The reflector 102 includes a first portion or first light reflecting conformation 108 for forming a substantially uniform spot beam angle and a second portion or second light reflecting conformation 110 different than the first conformation. The reflector further includes a base portion 114 for housing at least a portion of the HID light source. Terminals 120, 122 are connected to the light source 104 and extend through the base portion 114 for electrically coupling the base portion to a lamp socket (not shown). A rim 126 is located at a first or open end 128 of the second light reflecting conformation. The rim defines an opening adapted to receive a lens 130.

Similar to the prior art HID light source 54, the depicted HID light source 104, particularly a ceramic metal halide (CMH) light source, has elongated legs 140, 142 that extend from opposite axial ends of a discharge chamber or light emitting arc tube body 146. Thus, the light source includes spaced electrodes in the discharge chamber and suitable, conventional electrical and mechanical connections between the terminals 120, 122 and the electrical leads associated with the electrodes of the light source. An HID capsule 150 encloses the light emitting arc tube body 146 and legs 140, 142. Typically, the HID capsule 150 is secured with cement in a ceramic base 156. Likewise, the reflector is dimensioned to abut against the base, for example a necked-down portion may be received in the base and the reflector otherwise abutting against the base for accurate positioning of the light source, reflector, and base assembly. Because the first and second conformations 108, 110 of the bi-curved reflector 102 can accommodate the lengthy HID lamp capsule 150, the reflector, particularly the first light reflector conformation, is not elongated (compare with the reflector 42 of FIG. 2).

The first light reflecting conformation 108 is defined by an inner surface of revolution about a focal point. The inner surface of the first light reflecting conformation includes a plurality of facets 160 and a reflective coating. The facets provide optical control by gathering the light from the HID light source 104 to create a concentrated beam of light. It should be appreciated that other means for reflecting light is also contemplated. The first light reflecting conformation 108 is one of a substantially parabolic and substantially elliptical shape. In this illustrated embodiment, the first light reflecting conformation is parabolic. The second light reflecting conformation 110 extends generally normal from a plane defined by an open end of the first reflective section and can have a generally cylindrical shape. As shown in FIG. 3, the cylindrical shape is preferably tapered for ease of manufacturing of the reflector, particularly for mold release purposes.

As indicated above, conventional HID display lamps are generally restricted by the HID light emitting arc tube body size and shape (typically for a CMH light source, the light emitting body has a cylindrical shape approximately 6mm in diameter and 7 mm in length and the legs are approximately 12 mm in length). These conventional spot display lamps which include a single parabolic or elliptical shaped elongated to accommodate the HID light source, typically fail to achieve a desired spot beam angle, preferably on the order of less than approximately 15° spot beam angle, with good color and beam uniformity.

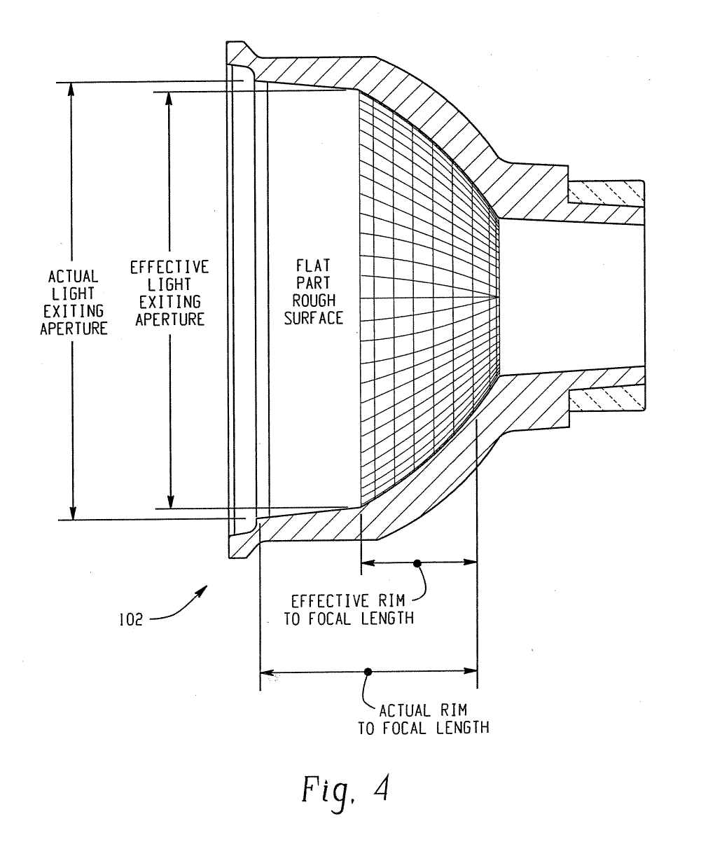

Conversely, with reference to FIG. 4, the bi-curved reflector 102 of the present disclosure obtains a less than approximately 15° spot beam angle having color uniformity and beam uniformity by shortening the effective length between the rim 126 and reflector focal point. By including the second light reflecting conformation 110, the bi-curved reflector 102 accommodates the elongate HID lamp capsule 150 while achieving an actual distance between the rim and reflector focal point of greater than approximately 18 mm and an effective distance of approximately 9 mm. Moreover, a distance between the reflector focal point and an end of the base portion 114 is greater than approximately 28 mm. Further, the parabolic or elliptical shaped first light reflecting conformation 108 can achieve the maximum light emitting aperture for MR lamps thereby providing increased lamp efficacy.

However, because light can reflect from the taper of the second light reflecting conformation 110, a bright ring is undesirably created around the uniform beam pattern at a wide angle (typically above 45° depending on the taper or draft angle of the cylindrical shaped second light reflecting conformation). To correct this problem, an inner surface of the second light reflecting conformation 110 includes means for diffusing light around the substantially uniform spot beam angle. For example, the diffusing light means on the inner surface of the second light reflecting conformation can include a non-reflective coating or a frosted or speckled surface to diffuse the light. Alternatively, the inner surface can be roughened by plunging a portion of the reflector mold. Still other alternative arrangements that diffuse the light directed by the second light reflecting portion can be used without departing from the scope and intent of the present disclosure.

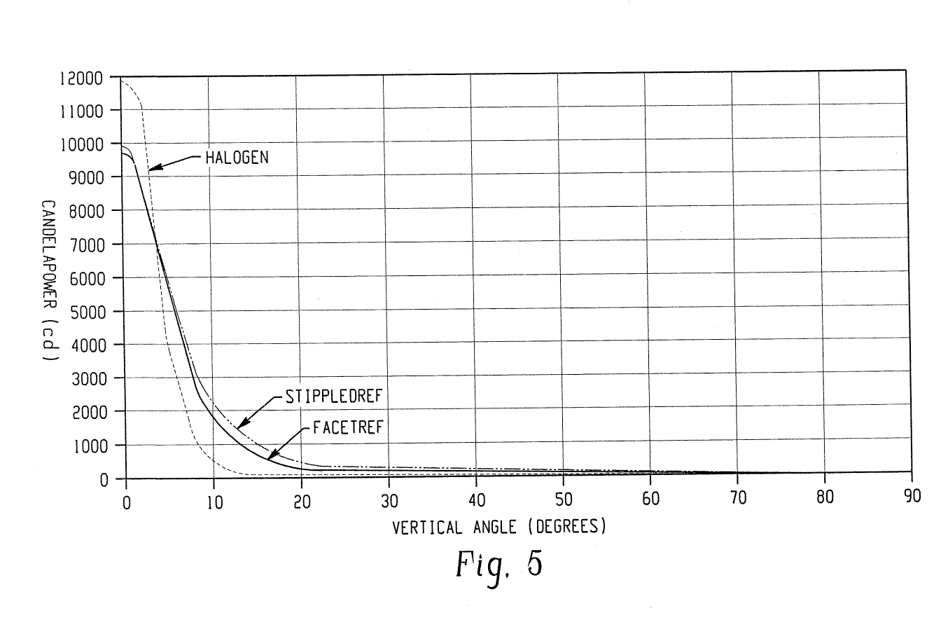

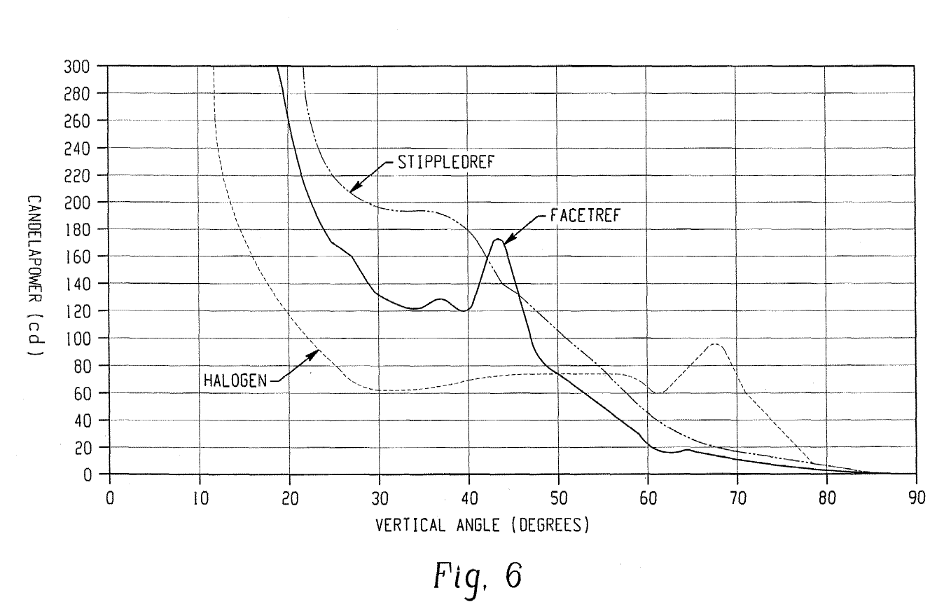

With reference to FIGS. 5 and 6, and by way of example only, illustrated are candela power distribution comparisons of a bi-curved halogen MR16 lamp (such as the GE Lighting Precise 42 W MR16 Halogen lamp), the HID display lamp 100 having no means for diffusing light around the substantially uniform spot beam angle (the “FacetRef—old CMH spot design”), and the HID display lamp 100 including means for diffusing light around the substantially uniform spot beam angle (the “StippledRef—new CMH spot design”). As shown in the comparisons, the conventional bi-curved 42 W halogen lamp produces a bright ring in a wide angle of approximately 67.5°. The HID display lamp without diffusing light means also produces a bright ring in a wide angle of approximately 45°. Conversely, and with additional reference to the Table below, the HID display lamp with light diffusing means produces no bright ring and demonstrates an approximate 11° spot beam angle with good color uniformity and beam uniformity and minimized spill lights. Moreover, the lumen (the rate at which a lamp produces light) of the 20 W MR16 display lamp according the present disclosure is about 63% higher than the lumen of the conventional 42 W bi-curved halogen MR16 lamp, which provides significant energy savings.

| | | | | Mirror | Total spilled |
|---|---|---|---|---|---|
| | Test# | CBCP | Beam angle | lumens | lights (lm) |
| Halogen | 567698-A1 | 13011 | 8 | 659 | 2 |
| | 567698-A2 | 11914 | 8.4 | 663 | 2 |
| | mean | 12463 | 8.2 | 661 | 2 |
| | std | 776 | 0.3 | 3 | 0 |
| CMH20W | 567698-B1 | 11768 | 10.4 | 999 | 16 |
| Old design | 567698-B2 | 9681 | 11.3 | 903 | 13 |
| | mean | 10725 | 10.9 | 951 | 15 |
| | std | 1476 | 0.6 | 68 | 2 |
| CMH20W | 567749-C1 | 10697 | 10.7 | 1051 | 2 |
| New | 567749-C2 | 12731 | 10.2 | 1102 | 3 |
| design | 567749-C3 | 12389 | 10.4 | 1082 | 3 |
| | mean | 11939 | 10.4 | 1078 | 3 |
| | std | 1089 | 0.3 | 26 | 0 |

As is evident from the foregoing, the present disclosure relates to a MR display spot lamp 100 including a bi-curved reflector 102 which can be used in high-intensity discharge lighting applications. The bi-curved reflector preferably includes one of a parabolic or elliptical shaped first reflective section 108 and a generally tapered cylindrical shaped second diffused section 110 extending outwardly from the first reflective section. The first reflective section is typically faceted and produces a uniform spot beam pattern having a less than approximately 15° spot beam angle. The second diffused section provides additional space to accommodate the elongated HID lamp capsule while maintaining an actual distance between a rim and reflector focal point of greater than approximately 18 mm. To improve the beam uniformity of the MR spot lamp 100, the inner surface of the second section can be one of frosted or speckled, i.e, a diffused light forming surface.

Though the present disclosure has been described with regard to an MR spot lamp, it will be understood that the disclosure could be applied to display lamps of different shapes and sizes without departing from the scope of the invention. For example, the bi-curved reflector 102 can be utilized in MR8 and MR11 display lamps having a HID light source, as well as any other HID reflector lamp known in the art.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A lamp comprising:
a high-intensity discharge light source; and
a reflector disposed to receive light from said high-intensity light source and direct the light in a desired manner, said reflector including a first light reflecting conformation for forming a substantially uniform spot beam angle and a second light reflecting conformation different than the first conformation.

2. The lamp according to claim 1, wherein said second light reflecting conformation includes means for diffusing light around the substantially uniform spot beam angle.

3. The lamp according to claim 2, wherein said light diffusing means includes a frosted surface.

4. The lamp according to claim 2, wherein said light diffusing means includes a generally tapered cylindrical shape.

5. The lamp according to claim 2, wherein said light diffusing means includes a speckled surface.

6. The lamp according to claim 1, wherein said reflector further includes a base, said base housing at least a portion of said high-intensity discharge light source.

7. The lamp according to claim 1, wherein said reflector further includes a rim located at an open end of said second light reflecting conformation, said rim defining an opening adapted to receive a lens.

8. The lamp according to claim 1, wherein said first light reflecting conformation includes a plurality of facets.

9. The lamp according to claim 1, wherein said first light reflecting conformation is one of a substantially parabolic and substantially elliptical shape.

10. The lamp according to claim 1, wherein a distance between a rim of said reflector and a focal point of said reflector is greater than approximately 18 mm.

11. The lamp according to claim 1, wherein said reflector obtains a less than approximately 15° spot beam angle having color uniformity and beam uniformity.

12. The lamp according to claim 11, wherein said first light reflecting conformation is one of a substantially parabolic and substantially elliptical shape.

13. The lamp according to claim 1, wherein a distance between a focal point of said reflector and an end of a base of said reflector is greater than approximately 28 mm.

14. A display lamp comprising:
a high-intensity discharge light source, and
a bi-curved reflector disposed to receive light from said high-intensity light source and direct the light in a desired manner, said reflector having a first reflective section shaped to form a spot beam angle and a second diffused section extending from said first reflective section having a diffused surface for diffusing light around the spot beam angle.

15. The lamp according to claim 14, wherein a distance between a rim of said reflector and a focal point of said reflector is greater than approximately 18 mm, said distance achieving less than approximately 15° spot beam angle having color uniformity and beam uniformity.

16. The lamp according to claim 14, wherein a distance between a focal point of said reflector and an end of a base of said reflector is greater than approximately 28 mm.

17. A display lamp comprising:
a reflector assembly, said reflector assembly including a high-intensity discharge light source and a bi-curved reflector disposed to receive light from said high-intensity light source and direct the light in a desired manner, said reflector having a first reflective section and a second diffused section extending from said first reflective section, wherein said bi-curved reflector shortens an effective distance between a rim located at an open end of said second diffused section and a focal point of said reflector, wherein said first reflective section achieves less than approximately 15° spot beam angle having color uniformity and beam uniformity.

18. The lamp according to claim 17, wherein an actual distance between said rim and said focal point is greater than approximately 18 mm.

19. The lamp according to claim 17, wherein a distance between said focal point of said reflector and an end of a base of said reflector assembly is greater than approximately 28 mm.

20. A lamp according to claim 17, wherein said first reflective section is one of substantially parabolic and substantially elliptical in shape.

21. The lamp according to claim 17, wherein said second diffused section extends generally normal from a plane defined by an open end of said first reflective section.

22. The lamp according to claim 21, wherein said second diffused section has a generally tapered cylindrical shape.
